(19) United States
(12) Patent Application Publication
(10) Pub. No.: US 2018/0176116 A1
(43) Pub. Date: Jun. 21, 2018

(54) Method and system for determining optimized paths of client devices

(71) Applicant: Man Wai IP, Hong Kong (HK)

(72) Inventor: Man Wai IP, Hong Kong (HK)

(21) Appl. No.: 15/379,496

(22) Filed: Dec. 15, 2016

(51) Int. Cl. H04L 12/26; H04L 12/24; H04L 29/06

(52) U.S. Cl. CPC H04L 43/50; H04L 43/10; H04L 65/80; H04L 41/0896

(57) ABSTRACT

According to embodiments of the invention, systems and methods are provided for determining optimal network connection paths for devices attempting to join a given network. The systems and methods generally employ sending testing and real data between network hubs and devices in order to gauge transmission and response speeds. The response time between the devices (i.e. a mobile device and a wireless router) is measured and used in determining expected bandwidth speeds to be experienced during the duration of the device's connection to the network. The methods and systems may be employed on networks having a plurality of routers in order to determine which router should be employed by a device requesting to join the overarching local network.

### FIELD OF THE INVENTION

The invention relates generally to networking, and more specifically, to optimized connection of multiple devices to a single network.

### BACKGROUND OF THE INVENTION

A local network may be formed by one or more routers that provide shared access communication medium for use by a number of client devices. A router implemented in a small local network can often be found in offices and homes. As part of its function, a router periodically broadcasts signals to enable any client devices within the range of the router to establish and maintain as a communication link within the local network. In a typical setup, only one client device may be associated with only one router. Due to the increasing bandwidth requirement in connecting multiple device clients to the network, more than one router is desirable. When a client device seeks to join a local network, the client device would then have a choice between multiple routers that form an high redundancy or load balancing setup.

Computer systems have long relied on communications between a control processor and remote terminals. More recently, communications also occur directly from terminal to terminal via a shared medium. In complex systems such as these, access to the medium must be carefully controlled to ensure not only that the system remains functional, but that it operates efficiently. Several methods have been developed to determine if terminals desire access to the medium and in what priority communication will be granted.

It is often necessary for electronic devices to communicate with one another in order to exchange data or to provide a centralized control mechanism for the operation of the devices within a particular environment. Typically, electronic devices communicate using an apparatus known as a “bus” or “data bus”. Although a bus typically consists of a wired communications channel physically connecting devices, it is also possible to construct a bus using a wireless (“tetherless”) communications channel. A wireless communications channel or a wireless bus offers significant advantages by eliminating the physical interconnect between devices. In order to permit efficient device communication, it is necessary to establish a communications protocol.

A communications protocol is a system for the exchange of information between devices and defines a particular communications architecture. For example, communicating devices are often configured in a host/peripheral relationship or a peer/peer relationship. In the host/peripheral arrangement, a host device typically communicates with one or more peripheral devices. A host periodically collects information from its peripherals or sends control information to the peripherals.

The process in which a host collects information from its peripherals is known as polling. The host dictates the polling communication sequence with its connected peripheral devices by determining when each peripheral device may ‘talk’ to the host. Under the polling process, unless the host sends permission to a peripheral device, the peripheral cannot send data to the host. The host/peripheral protocol is often referred to as an asymmetric protocol insofar as the host controls the peripherals' communication abilities. A typical example of a host/peripheral arrangement is a personal computer (PC) and its various peripheral devices. The host PC is responsible for orchestrating the exchange of data with its peripheral devices and periodically polls all of its peripherals in order to receive data regarding their current state. For example, a host PC will periodically poll its input devices such as the mouse and keyboard to detect events such as mouse movement or the press of key on the keyboard. Upon being polled, these input devices will transmit information regarding their current state to the host PC.

At present, client devices may use a received signal strength indicator to select the best available router to join that may be deemed as the best available router to associate with. However, such means do not provide any indication of the bandwidth that would be available to a client device that is trying to join the network, especially due to the challenge that each client device may have different operating bandwidth requirements. For example, a streaming client device such as a streaming player that downloads streaming video may download continuously videos from a streaming provider. Such a device may have a very high bandwidth requirement than a typical laptop for browsing static web pages. Currently, the new client device may use information indicating how many other client devices are currently associated with an router as an indication of the router's available capacity. However, the number of client devices currently associated with an router may not account for current activity (e.g., traffic levels and/or traffic types) of the associated client devices, and therefore may not provide an accurate indication of available bandwidth that can be allocated to new client devices. Thus, it would be desirable for client devices to have a more accurate estimate of the available bandwidth of routers when deciding which access point to associate with.

As such, there exists a need for methods and systems for client devices to have a more accurate estimate of the available bandwidth of routers when deciding which access point to associate with.

### SUMMARY OF THE INVENTION

According to embodiments of the invention, systems and methods are provided for determining optimal network connection paths for devices attempting to join a network. The systems and methods generally employ sending testing and real data between network hubs and devices in order to gauge transmission and response speeds. The response time between the devices (i.e. a mobile device and a wireless router) is measured and used in determining expected bandwidth speeds to be experienced during the duration of the device's connection to the network. The methods and systems may be employed on networks having a plurality of routers in order to determine which router should be employed by a device requesting to join the overall local network.

In an embodiment of the disclosed technology, a method is provided for determining, for newly-joined client devices, expected bandwidth that can made available to the newly-joined client devices by using a combination of testing data and real data of existing client devices within a local network. The method may be carried out, not necessarily in the following order, by: a) creating, by a first router, testing data to be sent to a first client, the first client being a newly-joined client device; b) preparing, by the first router, real data to be transmitted to a second client, the real data being requested by the second client that is an existing client device; c) preparing, by the first router, a transmission timetable for the testing data and the real data based on priority level of the first and second clients; d) starting a test by sending the testing data and real data to the first and second clients based on the timetable; e) measuring the response time of the testing data in reaching the first client; and/or f) determining, for the first client, the expected bandwidth of the first router in view of the priority level of the first client, based on the measured response time of the testing data.

In a further embodiment, the first client may be a smart phone device and the second client may be a video streaming device. Further, the referenced test may be conducted with increasing frequency using the testing data in order to acquire higher precision in the expected bandwidth. The first router is connected to a local area network. A network may be a wireless network, a wired network or any combination of wireless network and wired network. For example, a network may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11g or any other wired or wireless network for transmitting and/or receiving a data signal. In addition, a network may include, without limitation, telephone line, fiber optics, IEEE Ethernet 802.3, a Wide Area Network (“WAN”), a Local Area Network (“LAN”), or a global network such as the Internet. Also, a network may support, an Internet network, a wireless communication network, a cellular network, or the like, or any combination thereof.

In another embodiment of the disclosed technology, method is provided for determining, for newly-joined client devices, expected bandwidth servable to the newly-joined client devices by using a combination of testing data and real data of existing client devices within a local area network. The method may be carried out, not necessarily in the following order, by: a) creating, by a first router connected to the local network, testing data to be sent to a first client, the first client being a newly-joined client device; b) creating, by a second router connected to the local network, testing data to be sent to the first client; c) preparing, by the first router, real data to be transmitted to a second client, the real data being requested by the second client that is an existing client device; d) preparing, by the second router, real data to be transmitted to a third client, the real data being requested by the third client that is an existing client device; e) preparing, by the first router, a transmission timetable for the testing data and the real data based on priority level of the first and second clients; f) preparing, by the second router, a transmission timetable for the testing data and the real data based on priority level of the first and third clients; g) starting a test by sending the testing data and real data to the first, second, and third clients based on the timetables prepared by the first and second routers; h) measuring, by each of the first and second routers, the response time of the testing data in reaching the first client; and/or i) determining, for the first client, the expected bandwidth of the first router and the second router in view of the priority level of the first client, based on the measured response times of the testing data.

The first client may be, for example, a smart phone device. The second client may be, for example, a video streaming device. The third client may be a tablet device. The test may be conducted with increasing loads of the testing data in order to acquire higher precision in the expected bandwidth. The first client may choose either the first router or the second router as a default router based on the difference of the expected bandwidth between the first and second router.

In still another embodiment of the disclosed technology, a method is provided for determining, for newly-joined client devices, expected bandwidth that may be available to the newly-joined client devices by using a combination of testing data and real data of existing client devices within a local network. The method may be carried out, not necessarily in the following order, by: a) creating, by a first router, testing data to be sent to a first client, the first client being a newly-joined client device; b) preparing, by the first router, real data to be transmitted to a second client, the real data being requested by the second client that is an existing client device; c) preparing, by the first router, a transmission timetable for the testing data and the real data based on priority level of the first and second clients; d) starting a test by sending the testing data and real data to the first and second clients based on the timetable; e) measuring the response time of the testing data in reaching the first client; f) determining, for the first client, the expected bandwidth of the first router in view of the priority level of the first client, based on the measured response time of the testing data; g) if the measured response time of the testing data fails to meet a prescribed bandwidth requirement of the first client, redirecting connection, by the first router, to a second router that is not connected to the local area network; h) repeating the test with the second router by having the test data goes through the first router and the second router, and/or i) if the measure response time of the testing data meets the bandwidth requirement of the first client, setting up a default network path for the first client by going through both the first router and the second router.

Again, in this embodiment, the first client may be, for example, a smart phone device. The second client may be, for example, a video streaming device. The third client may be a tablet device. The test may be conducted with increasing loads of the testing data in order to acquire higher precision in the expected bandwidth. The first client may choose either the first router or the second router as a default router based on the difference of the expected bandwidth between the first and second router.

A better understanding of the disclosed technology will be obtained from the following brief description of drawings illustrating exemplary embodiments of the disclosed technology.

### BRIEF DESCRIPTION OF THE DRAWINGS

FIG. 1 shows a schematic visualization of an exemplary system configuration according to embodiments of the disclosed technology.

FIG. 2 shows a schematic visualization of a system having two routers according to embodiments of the disclosed technology.

FIG. 3 shows a flow chart outlining the steps of an exemplary method taken according embodiments of the disclosed technology.

FIG. 4 shows a schematic visualization of a system having two routers in communication with one another according to embodiments of the disclosed technology.

FIG. 5 shows a schematic visualization of a system having two routers, wherein one router serves multiple devices according to embodiments of the disclosed technology.

A better understanding of the disclosed technology will be obtained from the following detailed description of embodiments of the disclosed technology, taken in conjunction with the drawings.

### DETAILED DESCRIPTION

References will now be made in detail to the present exemplary embodiments, examples of which are illustrated in the accompanying drawings. Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

According to embodiments of the disclosed technology, systems and methods are provided for determining optimal network connection paths for devices attempting to join a network. The systems and methods generally employ sending testing and real data between network hubs and devices in order to gauge transmission and response speeds. The response time between the devices (i.e. a mobile device and a wireless router) is measured and used in determining expected bandwidth speeds to be experienced during the duration of the device's connection to the network. The methods and systems may be employed on networks having a plurality of routers in order to determine which router should be employed by a device requesting to join the overall local network.

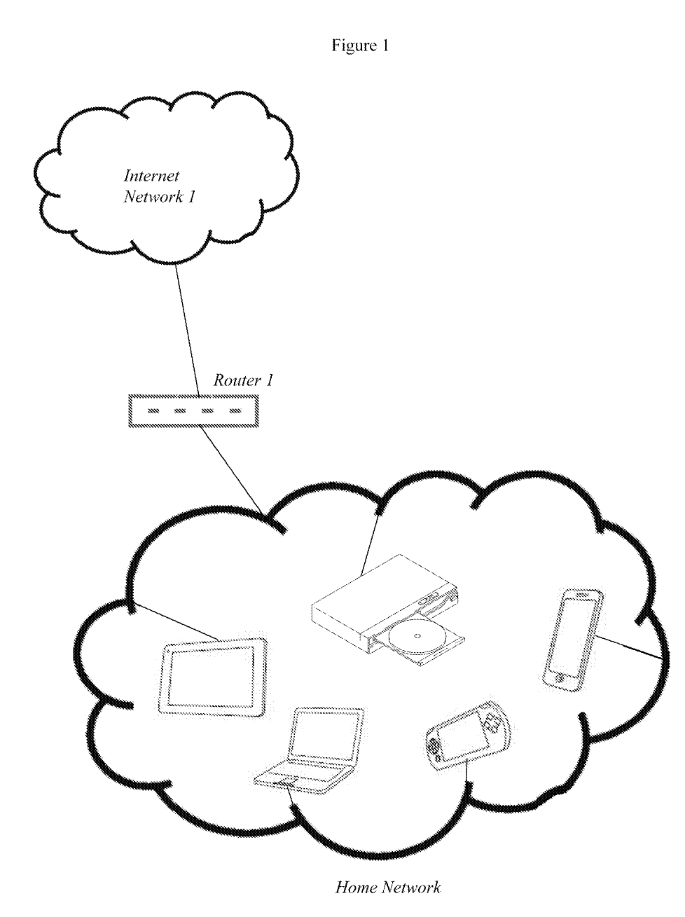

FIG. 1 shows a schematic visualization of an exemplary system configuration according to embodiments of the disclosed technology. The Figure shows the general setup for connection of local network devices to an Internet Network 1. The term “Internet” (upper-case “I”) refers to that particular global communications network that is in use around the world and that grew out of a U.S. Department of Defense funded research project named the ARPANet. Currently, most of the Internet is commercially owned and is an extremely complex, highly redundant network of telecommunications circuits that are connected together with routers. The “Internet” refers to a particular network of communications networks, while, in general, any interconnection of networks may be termed an “internet” (lower-case “i”). The “Internet” is one example of an “internet”. Currently, the Internet is used for a variety of services including communication, education, news, advertising, reference materials, broadcast like media, financial services, and other.

Companies termed Internet service providers (ISPs) lease access to these global networks from one of the global carriers and provide this access to their customers such as businesses, universities and individuals. These ISPs maintain their own IP (Internet protocol) networks that are connected to the Internet. An IP network of an ISP allows an ISP to establish a presence in many different locations around the country, so that customers will have local dial-in access or a short leased-line access to the IP network. Once a customer gains access to the IP network, he or she has access to the Internet. In reality, a hierarchy of local access providers, network service providers, and network access providers provide a link from a customer to the Internet.

In general, there are multiple components necessary to connect to facilitate an internet connection. These components include server computers, client computers, networks and routers. These components communicate with each other mainly over leased lines provided by the global carriers. A server is any computer on which information is stored and from which other computers, called clients, can retrieve that information. A client device is a computer used for accessing the Internet, retrieving information from server computers, entering data, and performing other data processing work. A client device may be used for word processing, sending e-mail, retrieving information from the Internet, transferring files, and many other tasks. A network is any interconnection of computers using wires, switches, network adapters, etc., that allow these computers to communicate.

A network may be a local area network (LAN), for example, or may be a wide area network (WAN). Networks are classified as LANs or as WANs depending upon their geographic reach. Networks are connected to each other via routers or gateways, forming internets. A network may be a wireless network, a wired network or any combination of wireless network and wired network. For example, a network may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11 g or any other wired or wireless network for transmitting and/or receiving a data signal. In addition, a network may include, without limitation, telephone line, fiber optics, IEEE Ethernet 802.3, a Wide Area Network (“WAN”), a Local Area Network (“LAN”), or a global network such as the Internet. Also, a network may support, an Internet network, a wireless communication network, a cellular network, or the like, or any combination thereof. A network may further include one, or any number of the exemplary types of networks mentioned above operating as a stand-alone network or in cooperation with each other. A network may utilize one or more protocols of one or more network elements to which it is communicatively coupled. A network may translate to or from other protocols to one or more protocols of network devices. It should be understood that according to one or more embodiments, a network may actually be composed of a plurality of interconnected networks, such as, for example, a service provider network, the Internet, a broadcaster's network, a cable television network, corporate networks, and home networks.

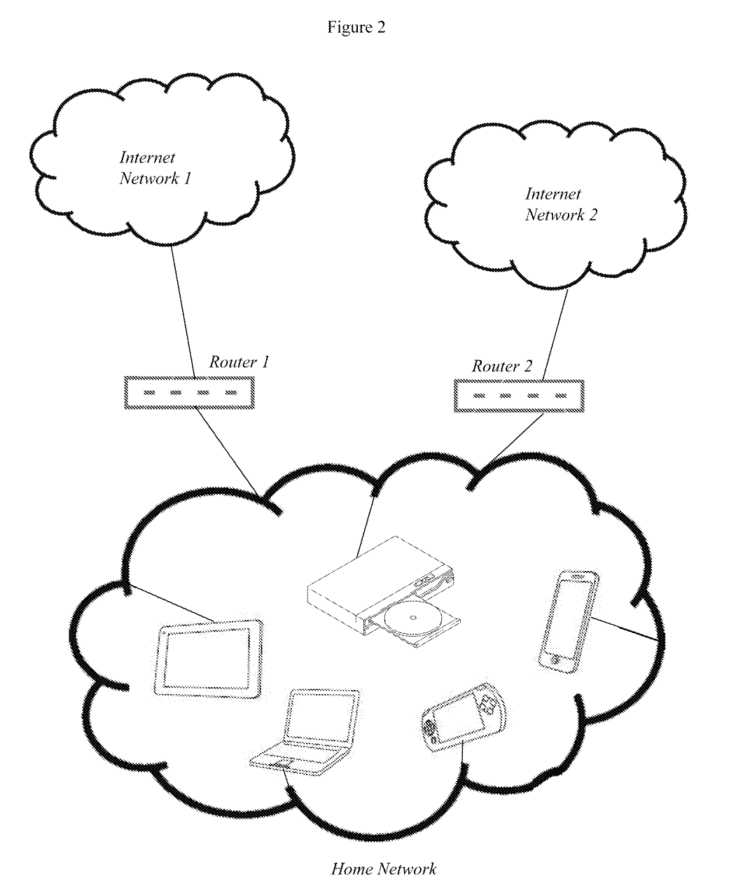

FIG. 2 shows a schematic visualization of a system having two routers according to embodiments of the disclosed technology. A second Internet Network 2 is depicted and is accessible via a second router, Router 2. In this embodiment, the client devices of the home network are within range and connectable to two different networks. As such, it may be desirable for both the Routers and the client devices to communicate with one another through a path best suited for the needs of the device. As such, according to the disclosed technology, a method may be employed to determine which router and network each device should connect through.

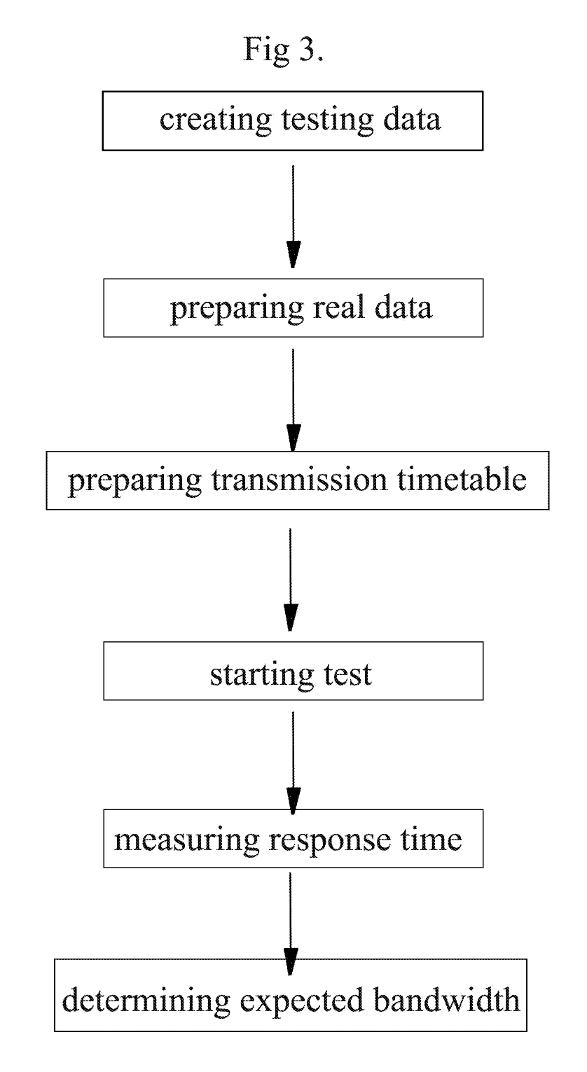

FIG. 3 shows a flow chart outlining the steps of an exemplary method taken according embodiments of the disclosed technology. The method may be carried out, not necessarily in the following order, by: a) creating, by a first router connected to the local network, testing data to be sent to a first client, the first client being a newly-joined client device; b) creating, by a second router connected to the local network, testing data to be sent to the first client; c) preparing, by the first router, real data to be transmitted to a second client, the real data being requested by the second client that is an existing client device; d) preparing, by the second router, real data to be transmitted to a third client, the real data being requested by the third client that is an existing client device; e) preparing, by the first router, a transmission timetable for the testing data and the real data based on priority level of the first and second clients; f) preparing, by the second router, a transmission timetable for the testing data and the real data based on priority level of the first and third clients; g) starting a test by sending the testing data and real data to the first, second, and third clients based on the timetables prepared by the first and second routers; h) measuring, by each of the first and second routers, the response time of the testing data in reaching the first client; and/or i) determining, for the first client, the expected bandwidth of the first router and the second router in view of the priority level of the first client, based on the measured response times of the testing data

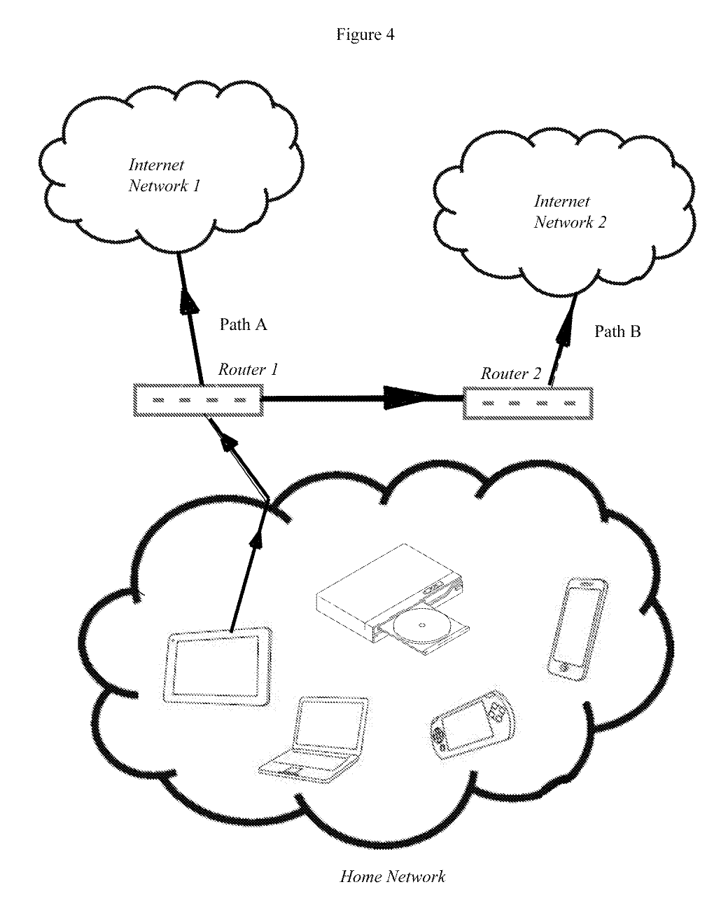

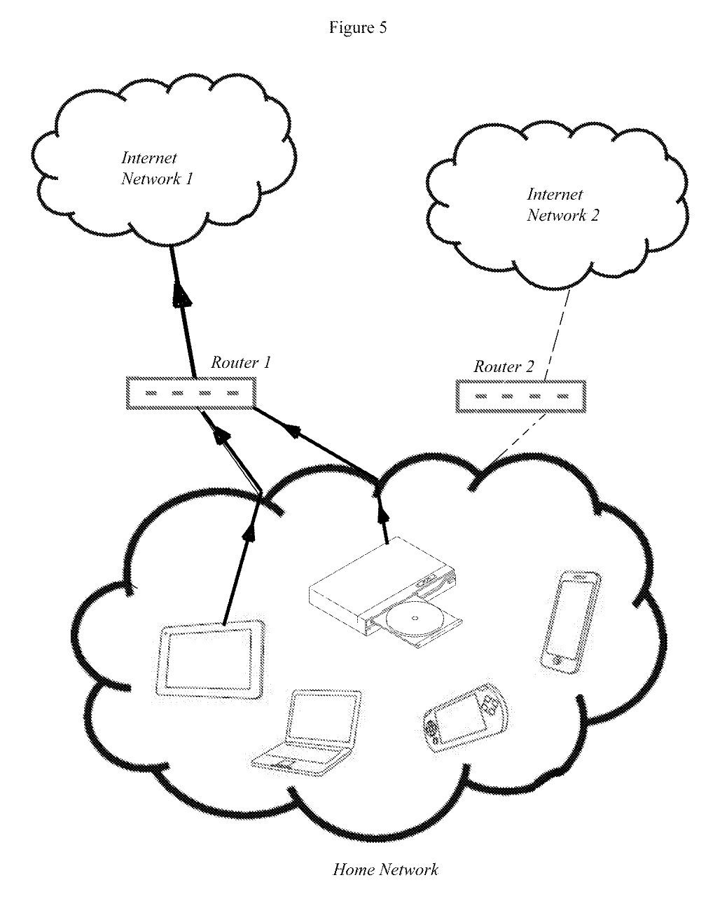

FIG. 4 shows a schematic visualization of a system having two routers in communication with one another according to embodiments of the disclosed technology. FIG. 5 shows a schematic visualization of a system having two routers, wherein one router serves multiple devices according to embodiments of the disclosed technology. An alternative method may result in these connection arrangements. One such method determines expected bandwidth that may be available to the newly-joined client devices by using a combination of testing data and real data of existing client devices within a local network. This method may be carried out, not necessarily in the following order, by: a) creating, by a first router, testing data to be sent to a first client, the first client being a newly-joined client device; b) preparing, by the first router, real data to be transmitted to a second client, the real data being requested by the second client that is an existing client device; c) preparing, by the first router, a transmission timetable for the testing data and the real data based on priority level of the first and second clients; d) starting a test by sending the testing data and real data to the first and second clients based on the timetable; e) measuring the response time of the testing data in reaching the first client; f) determining, for the first client, the expected bandwidth of the first router in view of the priority level of the first client, based on the measured response time of the testing data; g) if the measured response time of the testing data fails to meet a prescribed bandwidth requirement of the first client, redirecting connection, by the first router, to a second router that is not connected to the local area network; h) repeating the test with the second router by having the test data goes through the first router and the second router and/or i) if the measure response time of the testing data meets the bandwidth requirement of the first client, setting up a default network path for the first client by going through both the first router and the second router.

One skilled in the art will recognize that an implementation of an actual device will contain other components as well, and that each embodiment is a high level representation of some of the components of such a device for illustrative purposes. It should also be understood by one skilled in the art that the method and devices depicted in FIGS. 1 through 5 may be implemented on a device such as is shown in FIG. 5.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats-tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-levelprogramming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that ‘software’—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wikilLogic_gates (as of Jun. 5, 2012, 21:03 GMT).

The logic circuits forming the microprocessor are arranged to provide a microarchitecture that will carry out the instructions defined by that microprocessors defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wikilnstructions_per_second (as of Jun. 5, 2012, 21:04 GMT).

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language-functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand apply in a manner independent of a specific vendor's hardware implementation.

What is claimed:

1. A method of determining, for newly-joined client devices, expected bandwidth that can made available to the newly-joined client devices by using a combination of testing data and real data of existing client devices within a local network, the method comprising:
creating, by a first router, testing data to be sent to a first client, the first client being a newly-joined client device;
preparing, by the first router, real data to be transmitted to a second client, the real data being requested by the second client that is an existing client device;
preparing, by the first router, a transmission timetable for the testing data and the real data based on priority level of the first and second clients;
starting a test by sending the testing data and real data to the first and second clients based on the timetable;
measuring the response time of the testing data in reaching the first client; and
determining, for the first client, the expected bandwidth of the first router in view of the priority level of the first client, based on the measured response time of the testing data.

2. The method of claim 1, wherein the first client is a smart phone device and the second client is a video streaming device.

3. The method of claim 1, wherein the test is conducted with increasing frequency using the testing data in order to acquire higher precision in the expected bandwidth.

4. The method of claim 1, wherein the first router is connected to a local area network.

5. A method of determining, for newly-joined client devices, expected bandwidth servable to the newly-joined client devices by using a combination of testing data and real data of existing client devices within a local area network, the method comprising:
creating, by a first router connected to the local network, testing data to be sent to a first client, the first client being a newly-joined client device;
creating, by a second router connected to the local network, testing data to be sent to the first client;
preparing, by the first router, real data to be transmitted to a second client, the real data being requested by the second client that is an existing client device;
preparing, by the second router, real data to be transmitted to a third client, the real data being requested by the third client that is an existing client device;
preparing, by the first router, a transmission timetable for the testing data and the real data based on priority level of the first and second clients;
preparing, by the second router, a transmission timetable for the testing data and the real data based on priority level of the first and third clients;
starting a test by sending the testing data and real data to the first, second, and third clients based on the timetables prepared by the first and second routers;
measuring, by each of the first and second routers, the response time of the testing data in reaching the first client; and
determining, for the first client, the expected bandwidth of the first router and the second router in view of the priority level of the first client, based on the measured response times of the testing data.

6. The method of claim 5, wherein the first client is a smart phone device, the second client is a video streaming device, and the third client is a tablet device.

7. The method of claim 5, wherein the test is conducted with increasing loads of the testing data in order to acquire higher precision in the expected bandwidth.

8. The method of claim 5, wherein the first client chooses either the first router or the second router as a default router based on the difference of the expected bandwidth between the first and second router.

9. A method of determining, for newly-joined client devices, expected bandwidth that is available to the newly-joined client devices by using a combination of testing data and real data of existing client devices within a local network, the method comprising:
creating, by a first router, testing data to be sent to a first client, the first client being a newly-joined client device;
preparing, by the first router, real data to be transmitted to a second client, the real data being requested by the second client that is an existing client device;
preparing, by the first router, a transmission timetable for the testing data and the real data based on priority level of the first and second clients;
starting a test by sending the testing data and real data to the first and second clients based on the timetable;
measuring the response time of the testing data in reaching the first client;
determining, for the first client, the expected bandwidth of the first router in view of the priority level of the first client, based on the measured response time of the testing data;
if the measured response time of the testing data fails to meet a prescribed bandwidth requirement of the first client, redirecting connection, by the first router, to a second router that is not connected to the local area network;
repeating the test with the second router by having the test data goes through the first router and the second router; and
if the measure response time of the testing data meets the bandwidth requirement of the first client, setting up a default network path for the first client by going through both the first router and the second router.

10. The method of claim 9, wherein the first client is a smart phone device and the second client is a video streaming device.

11. The method of claim 10, wherein the test is conducted with increasing loads of the testing data in order to acquire higher precision in the expected bandwidth.
